(19) United States
(12) Patent Application Publication
(10) Pub. No.: US 2022/0365984 A1
(43) Pub. Date: Nov. 17, 2022

(54) DYNAMIC FILE IDENTIFICATION FROM SCREEN SHARING

(71) Applicant: INTERNATIONAL BUSINESS MACHINES CORPORATION, ARMONK, NY (US)

(72) Inventors: Roosevelt Faulkner, Austin, TX (US); Spencer Thomas Reynolds, Austin, TX (US); Matthew Cardinal, Austin, TX (US); Denise Bell, Austin, TX (US); Samuel Boyd Smith, III, Austin, TX (US)

(21) Appl. No.: 17/320,771

(22) Filed: May 14, 2021

(51) Int. Cl. G06F 16/951; G06F 16/904; G06F 16/955; G06F 16/954; G06N 20/00; G06K 9/62; H04L 29/06

(52) U.S. Cl. CPC G06F 16/951; G06F 16/904; G06F 16/955; G06F 16/954; G06N 20/00; G06K 9/6215; H04L 65/4069; G06K 2209/01

(57) ABSTRACT

A computer-implemented method, a computer system and a computer program product dynamically identify a shared document, or a similar document. The method includes establishing a screen sharing session, where a presenter computing device transmits a first image of a shared document to a participant computing device. The method also includes generating one or more search parameters by scanning the first image using optical character recognition or object recognition in response to receiving the first image at the participant computing device. The method further includes performing a search of one or more memories accessible to the participant computing device using the generated one or more search parameters. Finally, the method includes displaying a prioritized list of search results.

### FIELD

Embodiments relate generally to virtual meeting environments, and more specifically, to methods that dynamically identify shared content among participants of a virtual meeting.

### BACKGROUND

Participants in virtual meetings frequently use screen sharing features of the meeting application to enhance productivity and work from a common document. Screen sharing features allow a presenter on a computing device to share the display of all or part of a display screen to remote participants. The shared screen appears as the same image to all participants. The presenter may also provide documents ahead of the meeting to virtual meeting participants or everyone may have independent access to the documents used in the virtual meeting to enhance collaboration in virtual meetings.

### SUMMARY

An embodiment is directed to a computer-implemented method for dynamically identifying a shared document, or a similar document. The method may include establishing a screen sharing session, where a presenter computing device transmits a first image of a shared document to a participant computing device. The method may also include generating one or more search parameters by scanning the first image using optical character recognition or object recognition in response to receiving the first image at the participant computing device. The method may further include performing a search of one or more memories accessible to the participant computing device using the generated one or more search parameters. Finally, the method may include displaying a prioritized list of search results.

In an embodiment, a parameter within the generated one or more search parameters may be a URL. In this embodiment, the method may include determining whether the participant computing device is permitted to access a location specified by the URL. The method may also include accessing a document at the location by the participant computing device in response to determining that the participant computing device is permitted to access the location.

In a further embodiment, the method may include requesting permission for the participant computing device to access the location in response to determining that the participant computing device is not permitted to access the location.

In another embodiment, the presenter computing device may transmit a second image of the shared document. In this embodiment, the method may include receiving the second image at the participant computing device, wherein the second image is a second page of the shared document. The method may also include generating one or more second search parameters by scanning the second image using optical character recognition or object recognition in response to receiving the second image at the participant computing device. Finally, the method may include performing a search of the one or memories accessible by the participant computing device using the generated one or more second search parameters.

In yet another embodiment, the method may include determining a strength of similarity between the representation of the image and each of the search results. The method may also include ranking the search results in order of the determined strength of similarity. Finally, the method may include displaying the search results in order of the ranking.

In a further embodiment, the method may include displaying the search results on a participant computing device. The method may further include monitoring interactions of the participant computing device in navigating the search results. Finally, the method may include using a machine learning model to update the ranking based on the monitored interactions.

In another embodiment, the first image may include more than one shared document within a respective displayed boundary. In this embodiment, the method may include detecting the displayed boundary for each shared document within the first image. The method may also include partitioning the first image based on the detected displayed boundaries. The method mat further include generating one or more search parameters for each respective shared document by scanning each respective partition of the first image separately using optical character recognition or object recognition. In addition, the method may include performing a search of the one or more memories accessible to the participant computing device using the generated one or more search parameters for each respective shared document. Lastly, the method may include displaying a prioritized list of search results for each respective shared document.

In addition to a computer-implemented method, additional embodiments are directed to a system and a computer program product for dynamically identifying a shared document.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts a block diagram of internal and external components of the computers and servers depicted in FIG. 2, according to at least one embodiment.

FIG. 2 depicts a block diagram of a computing system that may be used to set up and conduct a virtual meeting over the network, according to an exemplary embodiment.

FIG. 3 depicts a flow chart diagram of a process to dynamically identify a shared document in accordance with one or more embodiments.

FIG. 4 depicts a screen shot of an example virtual meeting shared screen, according to an embodiment.

FIG. 5 depicts a block diagram of the inputs and machine learning model of a process to refine and update the results of a document search on a virtual meeting participant's computing device according to an embodiment.

FIG. 6 depicts a cloud computing environment according to an exemplary embodiment.

FIG. 7 depicts abstraction model layers according to an exemplary embodiment.

### DETAILED DESCRIPTION

As remote work and global collaboration grow, the use of collaboration tools such as video conferencing and virtual meetings is becoming more prevalent. During virtual meetings, the current presenter will often share their screen and show portions of a document or many documents. In these cases, the presenter may share the documents in advance but if not, it can be frustrating for participants who would like to review material covered or view additional content from the document that was not displayed on the screen share. The participants are required to dig through their local and shared cloud files to find the document being shared or documents with similar content. This action may result in the participant(s) missing key information, thereby wasting valuable collaboration time together. When documents or portions of documents are shared on a video conference, it is time consuming for everyone to dig across many directories to see if they already have access to the document, an old version of the document, or similar material that may be helpful during the video conference. What is needed is a way for meeting participants to scan images or documents through video conferencing and retrieve or obtain access to the document, an old version of the document, or relevant materials without having to dig for them manually.

Embodiments of the present invention detect content shared by a presenter in a virtual meeting over time for the purpose of dynamically searching a participant computing device's local and cloud directories for the document, older versions of the document, or other documents that closely match the content shared. The screen may be scanned at a participant computing device to capture a local image that may be converted into a text representation using techniques such as optical character recognition (OCR) or object recognition. This text may be entered into a local computer file search, including both local physical storage and files and folders in cloud directories that are accessible to the participant's device, to look for the same or similar files. For instance, the current screen shared within the virtual meeting may indicate a document title or URL that contains the content being shared. In such an instance, this information may be extracted and searched to find the document with the content. The body of eligible files to search, or search corpus, as well as the results of the search may be updated in real time as the meeting presenter screen changes. As an example, if the specific document has not been identified and the presentation has moved on to a second page that has better information to identify the document, such as the aforementioned URL or document title, the screen may be scanned again and converted to text, then searched at the participant computing device. If a specific document is identified in this procedure, then it may be opened automatically on the participant computing device.

In the event that a document cannot be specifically identified through this method, search results may be returned that may be ranked according to relevance or level of similarity to the searched text or content of the presentation or image on the shared screen. These results and rankings may be updated in real time in the same way as the search results are updated above, e.g., the screen may now show information that is more relevant to the search and a new scan and conversion cycle may be initiated to provide new information. In an embodiment, the search results and any real time update to the search results may be provided to a participant computing device within a virtual meeting and interactions with the search results from the participant computing device may be monitored. For example, something specific may be identified in the search results and a document that is lower in the rankings may be chosen. This choice may be noted and used to update the rankings, and therefore the order of results on the screen, to reflect preferences or information that is not readily available in a simple document search. In addition, explicit feedback may be sought about the search results that are provided, also to refine the rankings of the results and ordering on the screen.

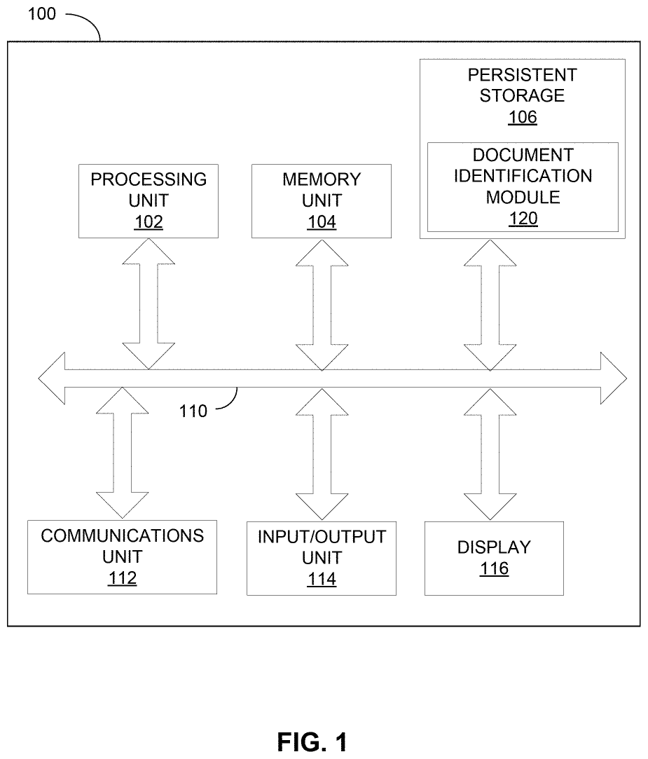

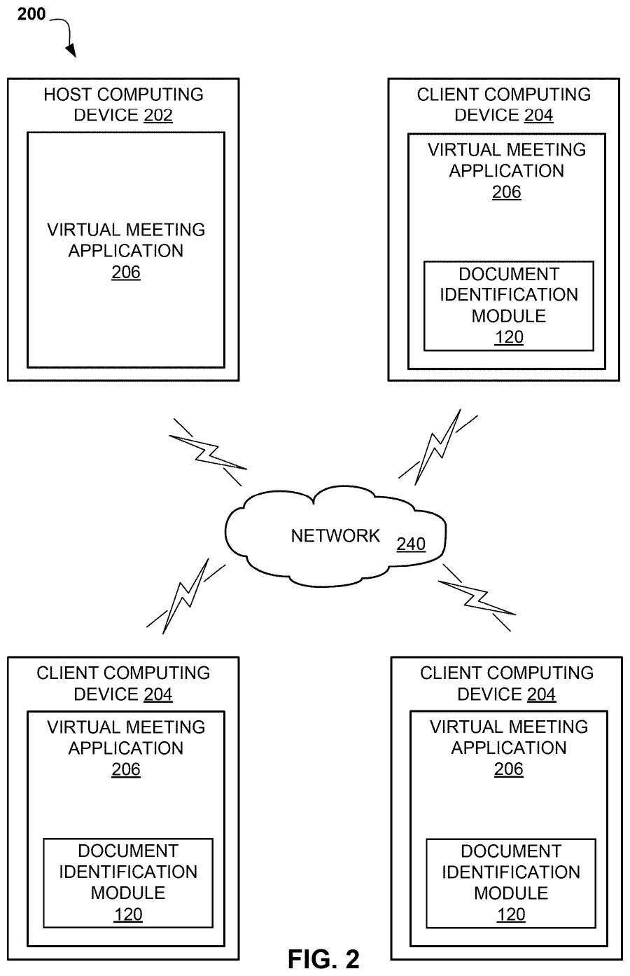

Referring to FIG. 1, a block diagram is depicted illustrating a computer system 100 which may be embedded in the host computing device 202 and client computing device 204 depicted in FIG. 2 in accordance with an embodiment. It should be appreciated that FIG. 1 provides only an illustration of one implementation and does not imply any limitations with regard to the environments in which different embodiments may be implemented. Many modifications to the depicted environments may be made based on design and implementation requirements.

As shown, a computer system 100 includes a processor unit 102, a memory unit 104, a persistent storage 106, a communications unit 112, an input/output unit 114, a display 116, and a system bus 110. Computer programs such as the document identification module 120 are typically stored in the persistent storage 106 until they are needed for execution, at which time the programs are brought into the memory unit 104 so that they can be directly accessed by the processor unit 102. The processor unit 102 selects a part of memory unit 104 to read and/or write by using an address that the processor 102 gives to memory 104 along with a request to read and/or write. Usually, the reading and interpretation of an encoded instruction at an address causes the processor 102 to fetch a subsequent instruction, either at a subsequent address or some other address. The processor unit 102, memory unit 104, persistent storage 106, communications unit 112, input/output unit 114, and display 116 interface with each other through the system bus 110.

Examples of computing systems, environments, and/or configurations that may be represented by the data processing system 100 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

Each computing system 100 also includes a communications unit 112 such as TCP/IP adapter cards, wireless Wi-Fi interface cards, or 3G or 4G wireless interface cards or other wired or wireless communication links. The document identification module 120 and the virtual meeting application 206 in the server may communicate with external computers via a network (for example, the Internet, a local area network or other wide area network) and respective network adapters or interfaces 112. From the network adapters or interfaces 112, the document identification module 120 and the virtual meeting application 206 in the server are loaded into the respective persistent storage 106.

Referring to FIG. 2, a block diagram of a computing system that may be used to conduct a virtual meeting is depicted, according to at least one embodiment. The networked computer environment 200 may include a meeting host computing device 202 and one or more client computing devices 204, interconnected via a communication network 240. According to at least one implementation, the networked computer environment 200 may include a plurality of client computing devices 204 of which only three are shown for illustrative brevity. One of ordinary skill in the art will appreciate that there is a single meeting host that may have overall control over the virtual meeting connections and the configuration depicted in FIG. 2 shows the host computing device 202 as the presenter. However, any of the computing devices connected to the virtual meeting may share the screen through the virtual meeting application 206 and be a presenter, and the host computing device 202 may receive the shared screen through the virtual meeting application 206 and be a participant. These alternate configurations are not shown in FIG. 2.

The communication network 240 may include various types of communication networks, such as a wide area network (WAN), local area network (LAN), a telecommunication network, a wireless network, a public switched network and/or a satellite network. The communication network 240 may include connections, such as wire, wireless communication links, or fiber optic cables. The network 240 may also include additional hardware not shown such as routers, firewalls, switches, gateway computers and/or edge servers. It may be appreciated that FIG. 2 provides only an illustration of one implementation and does not imply any limitations with regard to the environments in which different embodiments may be implemented. Many modifications to the depicted environments may be made based on design and implementation requirements. Accordingly, the communication network 240 may represent any communication pathway between the various components of the networked computer environment 200.

The host computing device 202 may be a laptop computer, netbook computer, personal computer (PC), a desktop computer, or any programmable electronic device or any network of programmable electronic devices capable of hosting and running the virtual meeting application 206, which includes screen sharing features. The screen sharing feature of the virtual meeting application 206 may be configured to allow a presenter utilizing the host computing device 202, as shown in FIG. 2, to share the video that is displayed, including a computer desktop and software application windows that are opened. The video that is shared may be a reproduction of the entire screen that is displayed locally at the computing device or a portion of the screen. In the case of a computing device with multiple screens, the virtual meeting application 206 may share any of the available screens. The presenter may configure the virtual meeting application 206 to display whatever screen is needed for the virtual meeting. As discussed with reference to FIG. 1, host computing device 202 may include computing system 100.

Client computing device 204 may include a virtual meeting application 206 that is displaying the screen that is shared by the host computing device 202 and configured to communicate with the other virtual meeting computer devices via the communication network 240, in accordance with an exemplary embodiment. The virtual meeting application 206 may provide a user interface in which a virtual meeting participant utilizing the client computing device 204 may view other participants and the presenter in the virtual meeting, as well as receive the screen image that is shared by the presenter from the host computing device 202 (as shown in FIG. 2), according to the exemplary embodiments. Client computing device 204 may be, for example, a mobile device, a telephone, a personal digital assistant, a netbook, a laptop computer, a tablet computer, a desktop computer, or any type of computing device capable of running a program and accessing a network. As discussed with reference to FIG. 1, the client computing device 204 may include computing system 100.

The document identification module 120 may operate in tandem with the virtual meeting application 206 on the client computing devices 204 in the configuration shown in FIG. 2. The module may be discrete software that is separately loaded into the computing device or may be embedded within the virtual meeting application 206 at the computing device. It will be appreciated by one of ordinary skill in the art that while the document identification module 120 operates at a computing device, it is not required that the software is physically loaded or installed on the hardware but may be on a server for the virtual meeting session. The same is true for the virtual meeting application 206 itself as the virtual meeting session may be fully in the cloud and hosted by a virtual meeting server that is not shown.

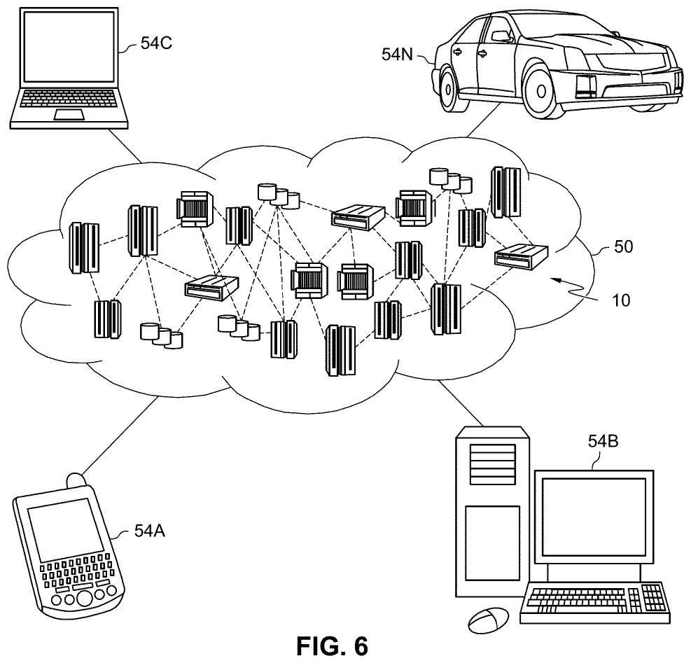

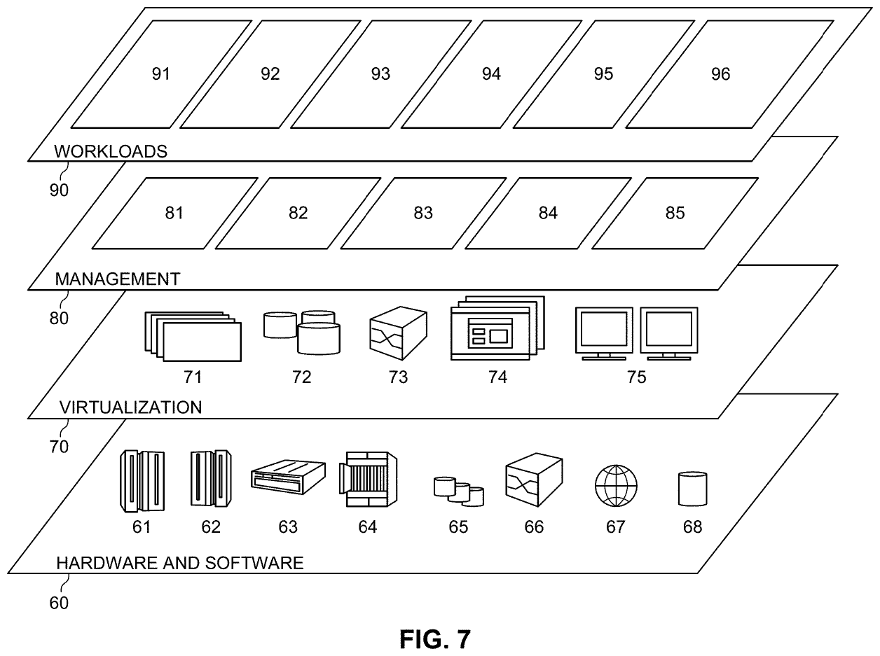

The host computing device 202 may communicate with the client computing devices 204 via the communication network 240, in accordance with embodiments of the invention. As will be discussed with reference to FIGS. 6 and 7, the virtual meeting application 206 running a virtual meeting on the host computing device 202 and client computing device 204 may also operate in a cloud computing service model, such as Software as a Service (SaaS), Platform as a Service (PaaS), or Infrastructure as a Service (IaaS). The servers running the virtual meeting application 206 on the devices participating in the virtual meeting may also be located in a cloud computing deployment model, such as a private cloud, community cloud, public cloud, or hybrid cloud.

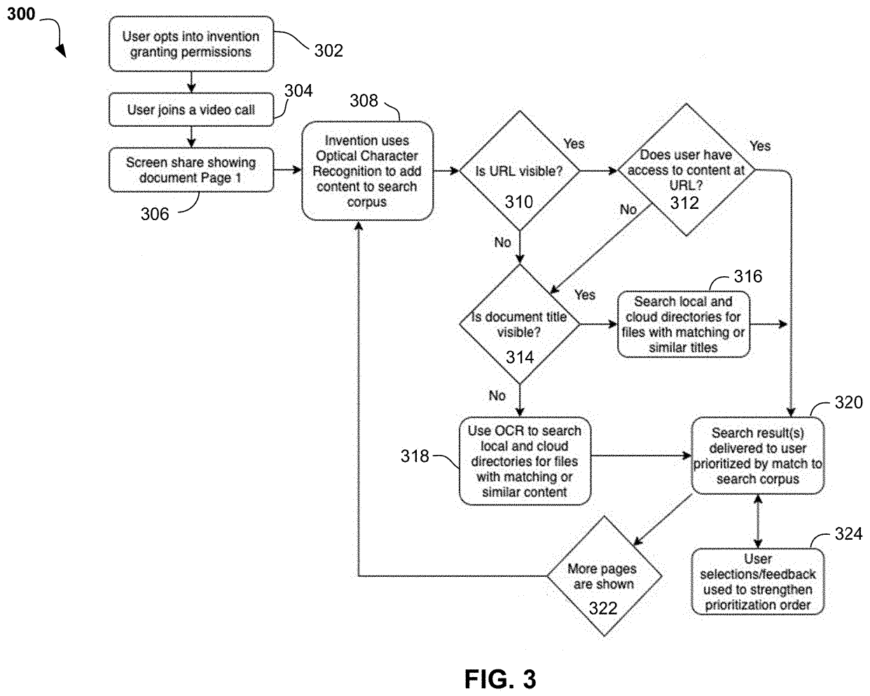

Referring to FIG. 3, an operational flowchart illustrating a process 300 to dynamically identify a shared document is depicted according to at least one embodiment. At 302, a virtual meeting host or participant may be given the opportunity to opt into allowing dynamic document identification on the computing device. This may be accomplished with an explicit dialog box that pops up at the time a virtual meeting is started or at the time the virtual meeting application 206, which may include the document identification module 120, is downloaded or any other appropriate method to indicate informed consent on the part of the participant. This may grant permission to index all existing and newly created local and cloud-based documents which are accessible to the participant's computing device and may be in addition to permission to monitor and process video and images shared during video conferences.

At 304, a participant may join a virtual meeting with an application, e.g., virtual meeting application 206, located on a client computing device 204 which allows many participants to join virtually with a single host and several participants. As mentioned with respect to FIG. 2, while it is required for the virtual meeting itself to have a single host computing device 202 that the clients use for connection purposes, it is not required that the host and the presenter be the same person as client computing devices 204 also have the ability to share their screen with the virtual meeting. Any person connected to the virtual meeting may be a presenter or a participant. For the purposes of dynamic document identification, once a meeting has begun and someone has shared their screen via the virtual meeting application 206, the remaining computing devices are considered participant computing devices and the originating, or presenter, computing device does not operate the document identification module 120, even if it is loaded on the computing device.

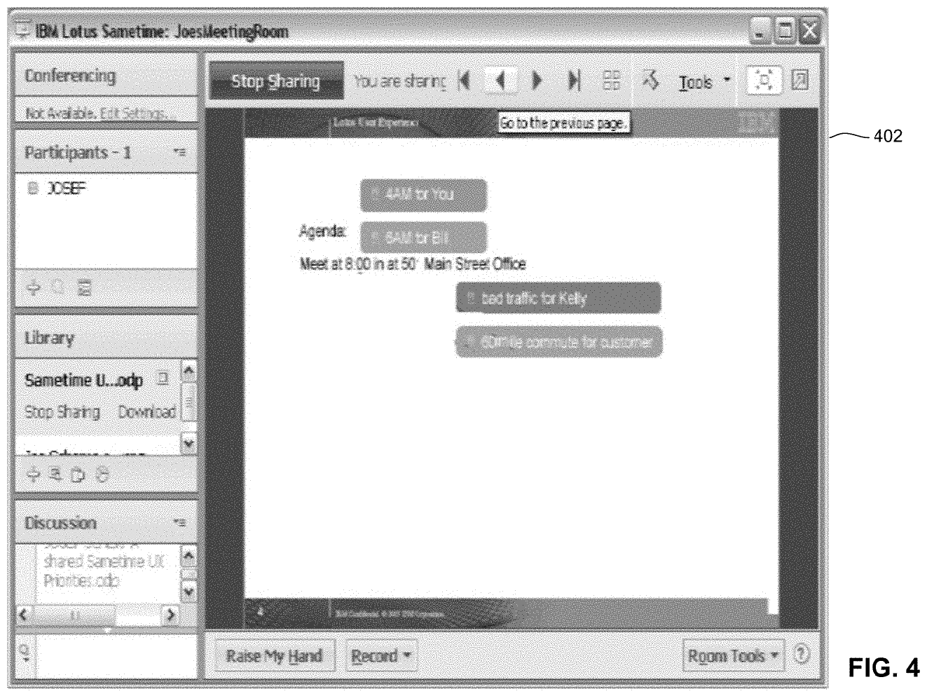

At 306, the presenter in the virtual meeting may begin screen sharing via the virtual meeting application 206 on the computing device, which transmits an image of the screen to all computing devices connected to the virtual meeting. This screen may have a document displayed and may include all or part of the local screen. This may be accomplished with the “share screen” function of the virtual meeting application 206 that is, for example, available in the software window 406 shown in FIG. 4. In an embodiment, if a window is not being shared full screen, computer vision techniques may be used to determine the window boundaries of documents being shared on the screen. If multiple windows, and therefore documents, are detected, the resulting image of a single scan of the screen may be partitioned into separate images and separate conversion of the images may be done to create multiple separate search corpora, one for each document. These searches may be done on the same local and cloud directories accessible to the participant's computing device but kept separate to indicate there are multiple documents to locate. However, it is not required to separate these searches if the participant wishes to locate multiple documents and the combined results may help with locating all documents.

At 308, at the computing devices that are receiving the screen within the virtual meeting, the visible shared screen may be scanned for content using one or more of optical character recognition (OCR) and object recognition. The result of the scan may be a text representation of the image on the participant computing device that may be used at the participant computing device to find results within a search corpus that includes the documents that may be accessible to the participant computing device. However, it is not necessary that a text representation be generated. Since object recognition techniques may be employed at this step, it may also be possible to identify similar documents from visuals or colors. For example, if multiple different types of files are shared on the screen, the different types of documents may be distinguished using those visuals or colors.

At 310, and in conjunction with steps 312, 314, 316 and 318, the content that may be extracted from the scan and conversion process and is representative of what may appear on the shared screen may be added to a dynamic document search as the search parameters. This process may prioritize URLs first, as shown in 310, then document titles, as shown in 314, and then document content as shown in 318. In step 310, it may be determined whether the shared screen contains a visible URL so that the location of the document may be found. If a URL is visible, then it may be determined if the participant computing device has been granted access to that location, which is step 312. If no URL is visible in the screen or cannot be acquired in the scan and conversion process of step 308, then the search process may move to its next priority, document title, in step 314.

At 312, a determination may be made as to whether the participant computing device has access to a specific URL that is contained in the shared screen and acquired through the prior scan of the screen that produces an image and conversion through OCR as described above. In this step, if the participant computing device has access to the location, the document may be retrieved and opened on the participant computing device, which may end the process of dynamically identifying the shared document. However, if access is not granted to this location for the participant computing device, then, in an embodiment, a request may be made automatically to request access or the search process may move to its next priority, document title, in step 314.

At 314, the text representation of the image of the shared screen may be checked to see if a document title is visibly displayed anywhere on the shared screen. If a document title is visible, then the local and cloud directories that are accessible to the participant computing device may be searched for a document that contains a matching or similar title, which is step 316. If no title is visible, then the search process may move to the next priority, general document content, in step 318.

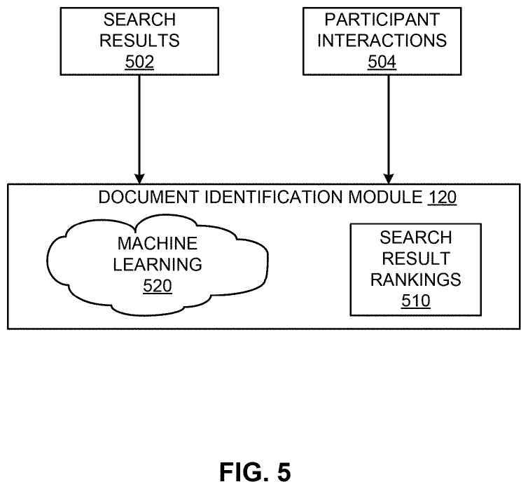

At 316, a determination may be made as to whether the local or cloud directories that are accessible from the participant computing device contain a document with a matching or similar title to the one that is visible on the screen and is contained in the output from the conversion process of step 308. If a matching title is found, the document containing the matching title may be opened on the participant computing device. If an exact match for the title is not found, documents with similar titles from the participant computing device's local and cloud directories may be added to a ranked list of search results. The ranking of the results may be in an order that may be determined by a similarity score. A number of modalities for assigning a similarity score to documents in the search results may be employed, for example cosine similarity. In addition, the determination of a similarity score, and therefore the ranking or order of display on the screen of the search results may be enhanced using a machine learning model in conjunction with explicit feedback from the participant computing device or the results of monitoring interactions with the ranked search results from the participant computing device. For instance, a specific type of document may be chosen many times or explicit feedback may be provided in the form of a preference or answer to a question. This activity may be captured in a machine learning model, as discussed in step 324 and FIG. 5 below. These ranked search results may be presented to the participant computing device in step 320 as choices to be manually opened based on whether any of them are a match for the document currently displayed on the shared screen.

At 318, with no URL or title being visible in the shared screen and therefore within the text representation of the screen image, the extracted general document content may be added to a search of the local and cloud directories accessible to the participant computing device. As in step 316, documents with similar content from the participant computing device's local and cloud directories may be added to a ranked list of search results. The ranking of the results may be in an order that may be determined by a similarity score. A number of modalities for assigning a similarity score to documents in the search results may be employed, for example cosine similarity. In addition, the determination of a similarity score, and therefore the ranking or order of display on the screen of the search results may be enhanced using a machine learning model in conjunction with explicit feedback from the participant computing device or the results of monitoring interactions with the ranked search results from the participant computing device. For instance, a specific type of document may be chosen many times or explicit feedback may be provided in the form of a preference or answer to a question. This activity may be captured in a machine learning model, as discussed in step 324 and FIG. 5 below. These ranked search results may be presented to the participant computing device in step 320 as choices to be manually opened based on whether any of them are a match for the document currently displayed on the shared screen.

At 320, the ranked search results may be displayed at the participant computing device with links to the cited similar documents in the participant computing device's local and cloud directories accessible to the participant computing device. As mentioned in steps 316 and 318, these search results may be presented as choices to be manually opened by the participant based on whether they are a match for the document currently displayed on the shared screen. Also mentioned above, the results may be ordered in the display based on a ranking that is itself based on a similarity score that has been assigned.

At 322, the ranked search results may also be updated as the shared screen is changed by the presenter in the course of the virtual meeting. For example, the presenter may start with a screen that names the presenter or gives a schedule of the presentation or some other page that is not highly descriptive of the presentation or does not have a URL or document title or information that is relevant to the virtual meeting participants. Once the presenter moves on to another page and the content that is visible on the shared screen changes, it may be possible to extract useful information. The screen may be scanned again and the image converted to text and this process may return to step 308 and carry out all the prior steps, which may be repeated as the image changes for as many times as necessary to add to the search parameters that may be used at the participant computing device. This repetition may be a cumulative process that dynamically adds to the search parameters or may be new, separate searches as the situation dictates. In an embodiment, the presenter may share multiple documents and a unique and dynamic set of ranked results may be generated for each document shared. The scanning and conversion process of step 308 may be repeated continually to ensure the search parameters include all of the content that has been shared from a document as the virtual meeting progresses.

At 324, as mentioned in steps 316 and 318, machine learning may be incorporated to improve the determination of the similarity score, and thus the rankings and order of search result display, as the process gains experience. This experience may lead to both improving match confidence and reducing the time it takes to serve potential matches to the meeting participant. As discussed in detail in FIG. 5, the machine learning model may work in conjunction with feedback from the participant computing device or monitored interactions of the participant computing device with the ranked search results. For instance, a specific type of document may be chosen many times or explicit feedback may be provided in the form of a preference or answer to a question. Once this activity is learned by the model, it may be used to train the model and refine the similarity score and ranking of the search results that are generated.

Referring to FIG. 4, an example of the user interface at the participant computing device is shown. In this example, a virtual meeting application window 402 is open and displayed in full screen mode. In this example, the frame of the virtual meeting application window 402 shows various features of the virtual meeting application, including the ability to share the screen.

Referring to FIG. 5, a diagram showing examples of components or modules of a process to refine and update the rankings of search results at a participant computing device according to at least one embodiment. According to one embodiment, the process may include document identification module 120 which utilizes supervised machine learning 520 to determine an appropriate ranking based on how a participant computing device interacts with search results. The supervised machine learning model may use an appropriate machine learning algorithm, e.g., Support Vector Machines (SVM) or random forests. The document identification module 120 may monitor the search results 502 that are obtained and displayed to a virtual meeting participant and track the participant computing device's interactions 504 with the search result. Participant interactions 504 are most commonly mouse clicks or another way to make an explicit choice of one of the search results but one of ordinary skill in the art will recognize that there are many ways for the machine learning model to collect information from the participant computing device about preferred choices in a list of search results. The document identification module 120 may use the above information to determine appropriate search result rankings 510 for an implementation and update the search results that are displayed based on those rankings that may be initially determined from a search using text converted from images that represent the screen of a remote presenter. The document identification module 120 may also obtain explicit feedback from multiple participant computing devices as a substitute for, or in addition to, the monitored interactions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66, such as a load balancer. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include mapping and navigation 91; software development and lifecycle management 92; virtual classroom education delivery 93; data analytics processing 94; transaction processing 95; and other applications 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for dynamically identifying a shared document comprising:
establishing a screen sharing session, wherein a presenter computing device transmits a first image of a shared document to a participant computing device;
in response to receiving the first image at the participant computing device, generating one or more search parameters by scanning the first image using optical character recognition or object recognition;
performing a search of one or more memories accessible to the participant computing device using the generated one or more search parameters; and
displaying a list of search results.

2. The computer-implemented method of claim 1, wherein when a parameter within the generated one or more search parameters being a URL, further comprising:
determining whether the participant computing device is permitted to access a location specified by the URL; and
in response to determining that the participant computing device is permitted to access the location, accessing a document at the location by the participant computing device.

3. The computer-implemented method of claim 2, further comprising:
in response to determining that the participant computing device is not permitted to access the location, requesting permission for the participant computing device to access the location.

4. The computer-implemented method of claim 1, wherein the presenter computing device transmits a second image of the shared document, further comprising:
receiving the second image at the participant computing device, wherein the second image is a second page of the shared document;
in response to receiving the second image at the participant computing device, generating one or more second search parameters by scanning the second image using optical character recognition or object recognition; and
performing a search of the one or memories accessible by the participant computing device using the generated one or more second search parameters.

5. The computer-implemented method of claim 1, wherein the displaying a list of search results comprises:
determining a strength of similarity between the representation of the image and each of the search results;
ranking the search results in order of the determined strength of similarity; and
displaying the search results in order of the ranking.

6. The computer-implemented method of claim 5, further comprising:
displaying the search results on a participant computing device;
monitoring interactions of the participant computing device in navigating the search results; and
using a machine learning model to update the ranking based on the monitored interactions.

7. The computer-implemented method of claim 1, wherein the first image includes more than one shared document within a respective displayed boundary, further comprising:
detecting the displayed boundary for each shared document within the first image;
partitioning the first image based on the detected displayed boundaries;
generating one or more search parameters for each respective shared document by scanning each respective partition of the first image separately using optical character recognition or object recognition;
performing a search of the one or more memories accessible to the participant computing device using the generated one or more search parameters for each respective shared document; and
displaying a list of search results for each respective shared document.

8. A computer system comprising:
one or more processors, one or more computer-readable memories, one or more computer-readable tangible storage media, and program instructions stored on at least one of the one or more tangible storage media for execution by at least one of the one or more processors via at least one of the one or more memories, wherein the computer system is capable of performing a method comprising:
establishing a screen sharing session, wherein a presenter computing device transmits a first image of a shared document to a participant computing device;
in response to receiving the first image at the participant computing device, generating one or more search parameters by scanning the first image using optical character recognition or object recognition;
performing a search of one or more memories accessible to the participant computing device using the generated one or more search parameters; and
displaying a list of search results.

9. The computer system of claim 8, wherein when a parameter within the generated one or more search parameters being a URL, further comprising:
determining whether the participant computing device is permitted to access a location specified by the URL; and
in response to determining that the participant computing device is permitted to access the location, accessing a document at the location by the participant computing device.

10. The computer system of claim 9, further comprising:
in response to determining that the participant computing device is not permitted to access the location, requesting permission for the participant computing device to access the location.

11. The computer system of claim 8, wherein the presenter computing device transmits a second image of the shared document, further comprising:
receiving the second image at the participant computing device, wherein the second image is a second page of the shared document;
in response to receiving the second image at the participant computing device, generating one or more second search parameters by scanning the second image using optical character recognition or object recognition; and
performing a search of the one or memories accessible by the participant computing device using the generated one or more second search parameters.

12. The computer system of claim 8, wherein the displaying a list of search results comprises:
determining a strength of similarity between the representation of the image and each of the search results;
ranking the search results in order of the determined strength of similarity; and
displaying the search results in order of the ranking.

13. The computer system of claim 12, further comprising:
displaying the search results on a participant computing device;
monitoring interactions of the participant computing device in navigating the search results; and
using a machine learning model to update the ranking based on the monitored interactions.

14. The computer system of claim 8, wherein the first image includes more than one shared document within a respective displayed boundary, further comprising:
detecting the displayed boundary for each shared document within the first image;
partitioning the first image based on the detected displayed boundaries;
generating one or more search parameters for each respective shared document by scanning each respective partition of the first image separately using optical character recognition or object recognition;
performing a search of the one or more memories accessible to the participant computing device using the generated one or more search parameters for each respective shared document; and
displaying a list of search results for each respective shared document.

15. A computer program product comprising:
a computer readable storage device storing computer readable program code embodied therewith, the computer readable program code comprising program code executable by a computer to perform a method comprising:
establishing a screen sharing session, wherein a presenter computing device transmits a first image of a shared document to a participant computing device;
in response to receiving the first image at the participant computing device, generating one or more search parameters by scanning the first image using optical character recognition or object recognition;
performing a search of one or more memories accessible to the participant computing device using the generated one or more search parameters; and
displaying a list of search results.

16. The computer program product of claim 15, wherein when a parameter within the generated one or more search parameters being a URL, further comprising:
determining whether the participant computing device is permitted to access a location specified by the URL; and
in response to determining that the participant computing device is permitted to access the location, accessing a document at the location by the participant computing device.

17. The computer program product of claim 16, further comprising:
in response to determining that the participant computing device is not permitted to access the location, requesting permission for the participant computing device to access the location.

18. The computer program product of claim 15, wherein the presenter computing device transmits a second image of the shared document, further comprising:
receiving the second image at the participant computing device, wherein the second image is a second page of the shared document;
in response to receiving the second image at the participant computing device, generating one or more second search parameters by scanning the second image using optical character recognition or object recognition; and
performing a search of the one or memories accessible by the participant computing device using the generated one or more second search parameters.

19. The computer program product of claim 15, wherein the displaying a list of search results comprises:
determining a strength of similarity between the representation of the image and each of the search results;
ranking the search results in order of the determined strength of similarity; and
displaying the search results in order of the ranking.

20. The computer program product of claim 19, further comprising:
displaying the search results on a participant computing device;
monitoring interactions of the participant computing device in navigating the search results; and
using a machine learning model to update the ranking based on the monitored interactions.
